(19) United States
(12) Patent Application Publication
(10) Pub. No.: US 2017/0193852 A1
(43) Pub. Date: Jul. 6, 2017

(54) METHOD FOR FOLDING CALIFORNIA STATE FLAG

(71) Applicant: Blake Carlyle Cooke, Roseville, CA (US)

(72) Inventor: Blake Carlyle Cooke, Roseville, CA (US)

(21) Appl. No.: 14/987,769

(22) Filed: Jan. 5, 2016

(51) Int. Cl. G09B 19/00

(52) U.S. Cl. CPC G09B 19/003

(57) ABSTRACT

Disclosed are the embodiments of a folded. California state flag. The method for folding applies to multiple sizes of California flags and the flag material can be nylon or cotton. The folded flag will have a triangular shape. The folded flag can be reproduced by one or more individuals and does not require special equipment or machinery. The completed folded flag can be encased in a standard three-corner flag case. The flag will retain the identity of the State of California.

### CROSS-REFERENCE TO RELATED APPLICATIONS

Not Applicable

### STATEMENT REGARDING FEDERALLY SPONSORED RESEARCH OR DEVELOPMENT

Not Applicable

REFERENCE TO SEQUENCE LISTING, A TABLE, OR A COMPUTER PROGRAM LISTING COMPACT DISC APPENDIX

Not Applicable

### FIELD OF INVENTION

The present teachings relate to the folding of the California state flag for ceremonial purposes and for displaying in flag cases.

### BACKGROUND OF INVENTION

No official guidance nor California Government Code currently exists for the folding of the California state flag so that it can be displayed in a standard flag case. California state flags can be folded using the traditional method for folding the United States flag, However, the result is a triangle shaped piece of cloth devoid of identity. If the California state flag is folded like the United States flag, the observer is unable to determine the folded flag is of the State of California.

The general purpose of a flag case is to protect and display a folded flag. There is a need for the California state flag to be folded and displayed in such a way as to retain the identity of the State of California in such a case.

Many traditional and formal ceremonies involve the folding of a flag. There is a need for an easily-repeatable process to fold the California state flag in such a way as to pay honor and show respect in such a ceremony that could result in a folded California state flag which can be encased.

### BRIEF SUMMARY OF THE INVENTION

Various aspects of the present teachings relate to a process for folding the California state flag.

In various embodiments, the process can comprise, for example:

1. A standard rectangular California state flag of cloth material. The said flag shall consist of a length equal to one and one-half the width thereof; the upper five-sixths of the width thereof to be a white field, and the lower sixth of the width thereof to be a red stripe; there shall appear in the white field in the upper left-hand corner a single red star, and at the bottom of the white field the words “CALIFORNIA REPUBLIC”, and in the center of the white field a California grizzly bear upon a grass plat, in the position of walking toward the left of the said field; said bear shall be dark brown in color and in length, equal to one-third of the length of said flag.

2. The flag is folded in half horizontally with the words “CALIFORNIA REPUBLIC” outward facing and creased. The flag is folded in half once more horizontally and creased.

3. The rectangular shape is flipped over so the words “CALIFORNIA REPUBLIC” are not visible.

4. Nine alternating triangular folds are accomplished, starting from the top right folding over to the opposing edge and creased. Each alternating fold should be “tight” and creased. This is continued until “CAL” or “CALI” are the only text that remains visible. There should be excess to the left of the folds.

5. The remaining excess is folded from the top and tucked into the folds to complete the triangle shape. The final triangle shape is creased.

Various embodiments relate to a product produced by the method as set forth above. In a variety of embodiments, the product is made from a single California state flag. According to a variety of embodiments, the single California state flag has two standard sizes: Small, which has a width of 3 feet and a length of 4 feet; And Large, which has a width of 4 feet and a length of 6 feet. In various embodiments, the product is devoid of any cut, slit, perforation, hole, tear, or any combination thereof. In accordance with various embodiments, the product can be comprised of nylon or cotton material.

Further aspects of the present teachings relate to a folded California state flag. In various embodiments, each flag is configured to be displayed in a typical flag case, shadow box, or enclosure.

Further aspects of the present teachings provide for a repeatable process that can be duplicated for formal ceremonies or in front of an audience.

### BRIEF DESCRIPTION OF THE DRAWINGS

FIGS. 1-15 depicts a method for producing a folded State of California flag according to various embodiments of the present invention.

FIG. 16 shows a product produced by a method for producing a folded State of California flag.

### DETAILED DESCRIPTION OF THE INVENTION

Various non-limiting, exemplary embodiments will now be described.

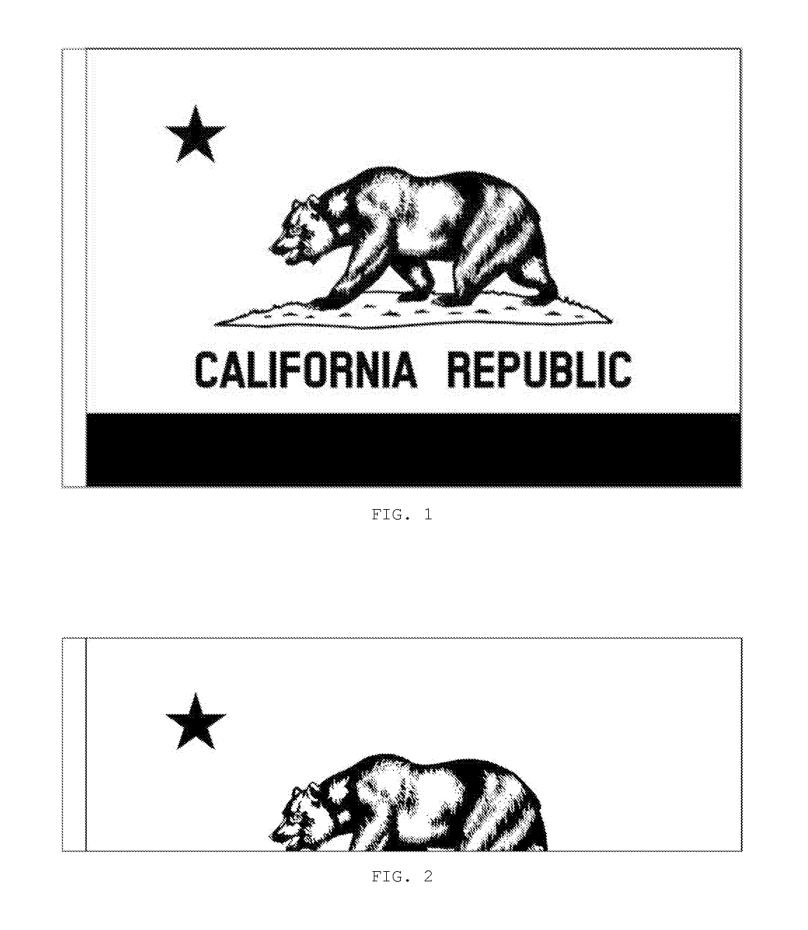

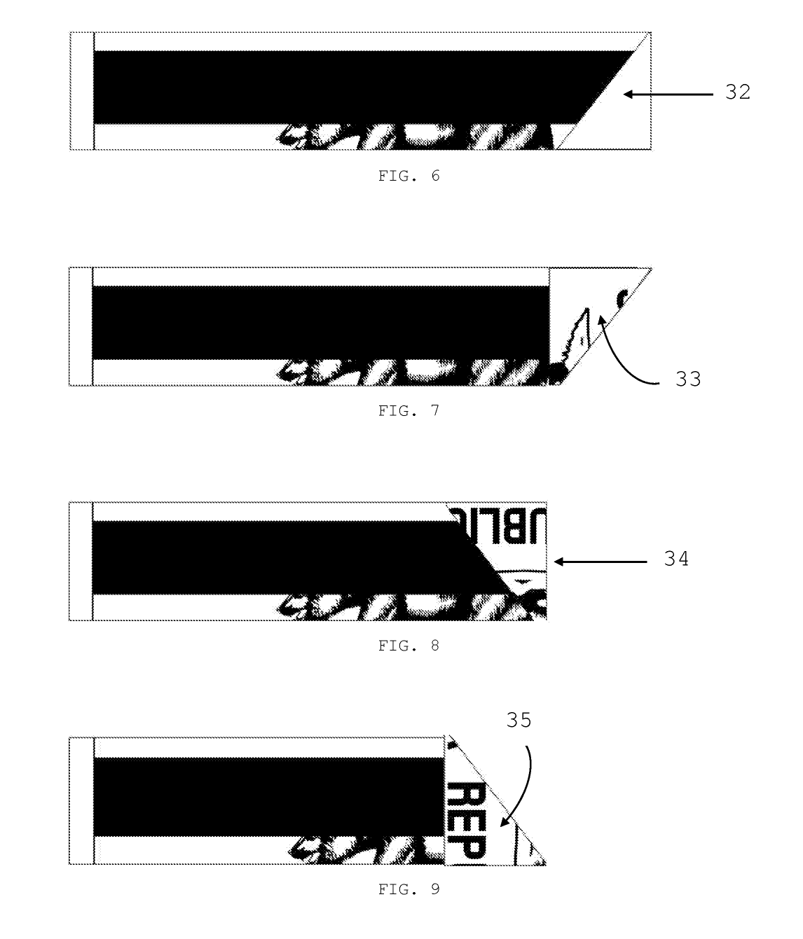

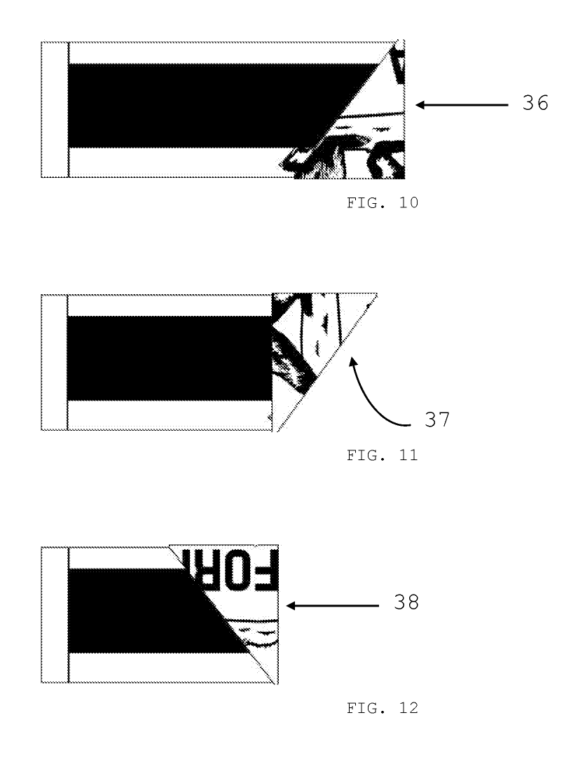

According to various embodiments, and with reference to FIGS. 1-14, a folded State of California flag can be constructed as follows:

FIG. 1 shows a standard rectangular California state flag of cloth material. The said flag shall consist of a length equal to one and one-half the width thereof; the upper five-sixths of the width thereof to be a white field, and the lower sixth of the width thereof to be a red stripe; there shall appear in the white field in the upper left-hand corner a single red star, and at the bottom of the white field the words “CALIFORNIA REPUBLIC”, and in the center of the white field a California grizzly bear upon a grass plat, in the position of walking toward the left of the said field; said bear shall be dark brown in color and in length, equal to one-third of the length of said flag.

FIG. 2 shows the flag folded in half horizontally with the words “CALIFORNIA REPUBLIC” outward-facing and creased. FIG. 3 shows the flag folded in half once more horizontally and creased.

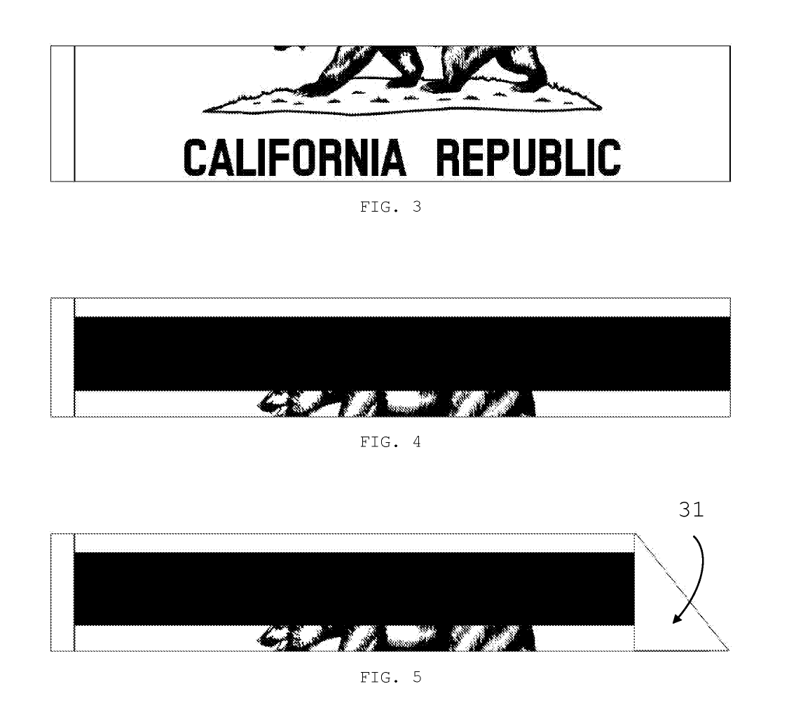

FIG. 4 shows the flag flipped over so the words “CALIFORNIA REPUBLIC” are not visible.

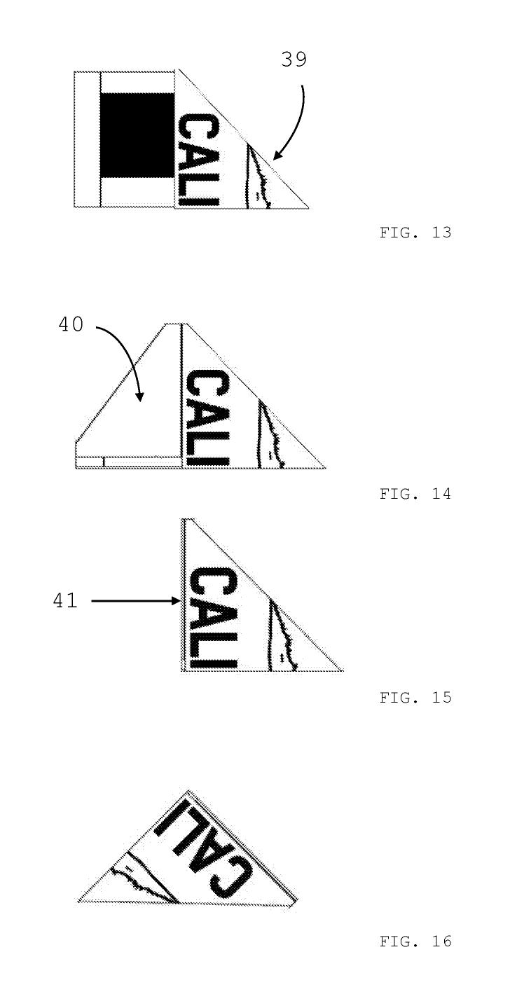

FIGS. 5-13 show nine alternating triangular folds starting from the top right folding over to the opposing edge 31 and creased. Each alternating fold should be “tight” and creased. This is continued until “CAL” or “CALI” are the only text that remains visible. 32 shows the direction of the next fold from right to left. 33 shows the direction of the next fold from bottom towards the top. 34 shows the direction of the next fold from right to left. 35 shows the direction of the next fold from top towards the bottom. 36 shows the direction of the fold from right to left. 37 shows the direction of the fold from bottom towards the top. 38 shows the direction of the next fold from right to left. 39 shows the final triangular fold from the top towards the bottom. At this point, there should be excess to the left of the folds. FIG. 13 shows the remaining excess.

FIG. 14 shows the excess folded from the top 40.

FIG. 15 shows the excess tucked into the folds 41 to complete the triangle shape.

FIG. 16 shows the final triangle shape, which is creased.

Each reference cited herein is incorporated herein by reference in its entirety for all purposes.

While the principles of the present teachings have been illustrated in relation to various exemplary embodiments shown and described herein, the principles of the present teachings are not limited thereto and include any modifications, alternatives, variations and/or equivalents thereof.

1. A process for folding the California state flag comprising:
A) A standard rectangular California state flag of cloth material. The said flag shall consist of a length equal to one and one-half the width thereof; the upper five-sixths of the width thereof to be a white field, and the lower sixth of the width thereof to be a red stripe; there shall appear in the white field in the upper left-hand corner a single red star, and at the bottom of the white field the words “CALIFORNIA REPUBLIC”, and in the center of the white field a California grizzly bear upon a grass plat, in the position of walking toward the left of the said field; said bear shall be dark brown in color and in length, equal to one-third of the length of said flag.
B) The flag is folded in half horizontally with the words “CALIFORNIA REPUBLIC” outward facing and creased. The flag is folded in half once more horizontally and creased.
C) The rectangular shape is flipped over so the words “CALIFORNIA REPUBLIC” are not visible.
D) Nine alternating triangular folds are accomplished, starting from the top right folding over to the opposing edge and creased. Each alternating fold should be “tight” and creased. This is continued until “CAL” or “CALI” are the only text that remains visible. There should be excess to the left of the folds.
E) The remaining excess is folded from the top and tucked into the folds to complete the triangle shape. The final triangle shape is creased.

2. A repeatable process by the method of claim 1 which can be performed at formal ceremonies or in front of an audience.

3. A product produced by the method of claim 1.

4. The product of claim 3, wherein said product maintains the identity of the State of California.

5. The product of claim 3, wherein said product can be protected and displayed in a standard flag case.
